(19) United States
(12) Patent Application Publication
(10) Pub. No.: US 2006/0175248 A1
(43) Pub. Date: Aug. 10, 2006

(54) Fluid filtering straw

(76) Inventors: Nancy Raimondo, Miami, FL (US); Andres Ranz, Miami, FL (US)

Correspondence Address: Nancy Raimondo, 651 NE 203 Lane, Miami, FL, 33179, US

(21) Appl. No.: 11/301,317

(22) Filed: Dec. 13, 2005

Related U.S. Application Data
(60) Provisional application No. 60/650,118, filed on Feb. 7, 2005.

(51) Int. Cl. B01D 29/11

(52) U.S. Cl. 210/497.01

(57) ABSTRACT

Disclosed is a cylindrical elongated tube with a first and an opposite second end, the first end capable of being received within a consumer's mouth for suction and the second end leading to an expanded filtering section perpendicular to said cylindrical elongated tube forming an inverse ‘T’ structure, the filtering section having at least two walls with a plurality of perforations thereof to filter particles of a predetermined size in a fluid through the plurality of perforations and allow the fluid to pass through the elongated tubular glass filtering structure for consumption.

### CLAIM OF BENEFIT TO PRIOR APPLICATIONS

This patent application claims the benefit of the earlier-filed U.S. Provisional Patent Application entitled “GLASS FILTERING TUBE, HEALTH TEA WAND”, having APPL. No. 60/650,118, filed on Feb. 07, 2005.

### FIELD OF THE INVENTION

The present invention relates generally to filtering devices and more specifically to drinking straws for straining out of predetermined suspended particles e.g. tea leaves, coffee, herbal infusions, solids, or the like, from fluids and preventing lips from burning during the oral absorption of fluids.

### BACKGROUND OF THE INVENTION

The fluids used for consumption comprises a lot of unwanted particles or impurities affecting the taste and flavor of the desired fluid. This necessitates the need for filtering the fluid before and during consumption. Filtering the fluid separately is a cumbersome process. Various fluid filtering and drinking devices are available in the market that has attempted to address this issue. The filtering straws available in the market are always not portable, hygienic, and easy for use. The use of conventional drinking straws made of stainless steel and other metals for filtering and drinking fluids like tea, coffee, etc., results in large fluid particles clogging and being ingested through the metal straw, lips burning during the oral absorption of the fluid, and the absorption of the metal particles from the straw, after numerous uses, due to metal deterioration.

U.S. Pat. No. 5,509,605 discloses a filtering straw for drawing a liquid from a container having a tubular structure with a pair of filters. Each of the filters includes a portion extending from the corresponding end of the tube for removing different type of impurities. This patent does not provide effective means for preventing lips from burning during the oral absorption of fluids and straining out of predetermined suspended particles e.g. tea leaves, coffee, herbal infusions, solids, or the like, from fluids.

U.S. Pat. No. 6,109,538 discloses a flavoring delivery drinking straw for adding a flavoring to a liquid passing through the drinking straw. The flavoring delivery drinking straw includes an elongate tube with spaced apart pair of screens disposed in the lumen of the tube to block passage of objects greater than a predetermined size through the lumen of the tube. A flavoring object is disposed in the lumen of the tube between the screens for imparting a flavor to a liquid passing through the lumen of the tube. This patent does not provide effective means for straining out of unwanted particles or impurities from the fluid which affects the taste and flavor of the desired fluid.

U.S. Patent Publication No. 20020092919 discloses a filtered drinking straw for filtering liquids passing through a drinking straw. The filtering apparatus is attached to the upright tube possessing a pair of positioned aperture ends that is capable of preventing particles of predetermined sizes. The filtering apparatus is affixed at one end or can be made to run to a predetermined length of the tube. This patent does not provide means for straining out of unwanted particles from the fluid and preventing lips from burning during the oral absorption of fluids.

None of the prior arts provides a simple structure, hygienic, cost effective, and portable fluid filtering and consuming device which is capable of straining out predetermined suspended particles e.g. tea leaves, coffee, herbal infusions, solids, or the like, from fluids and preventing lips from burning during the oral absorption of fluids.

Therefore, there exists a need for a simple, hygienic, cost effective, and portable fluid filtering and consuming device which is: a single piece to avoid complications of assembling; having a larger surface area of filtration for straining out of predetermined suspended particles e.g. tea leaves, coffee, herbal infusions, solids, or the like from fluids; and capable of stopping absorption of the metal particles from the straw, preventing lips from burning during the oral absorption of fluids, and overcoming the problems of large fluid particles clogging and ingestion through the metal straw.

### SUMMARY OF THE INVENTION

In view of the foregoing disadvantages inherent in the above-mentioned prior arts, the general purpose of the present invention is to provide an improved combination of convenience and utility, to include all the advantages of the prior arts, and to overcome the above-mentioned disadvantages/drawbacks of the prior art.

In another aspect, the present invention provides an elongated tubular filtering structure with an open first end and an opposite expanded second end. The second end has a plurality of perforations enabling the elongated tubular filtering structure to filter particles of a predetermined size in a fluid through the plurality of perforations and allow the fluid to pass through the elongated tubular filtering structure for consumption.

In another aspect, the present invention provides an elongated tubular glass filtering structure having a cylindrical elongated tube with a first and an opposite second end. The first end is capable of being received within a users's mouth for suction and the second end leading to an expanded filtering section perpendicular to the cylindrical elongated tube forming an inverse ‘T’ structure. The filtering section having at least two walls with a plurality of perforations thereof to filter particles of a predetermined size in a fluid through the plurality of perforations and allow the fluid to pass through the elongated tubular glass filtering structure for consumption.

In another aspect, the present invention provides a simple, hygienic, cost effective, and portable fluid filtering and consuming device which is: a single piece to avoid complications of assembling; having a larger surface area of filtration for straining out predetermined suspended particles e.g. tea leaves, coffee, herbal infusions, solids, or the like from fluids; and capable of preventing lips from burning during the oral absorption of hot fluids, and overcoming the problems of large fluid particles clogging and ingestion through metal straws.

These together with other aspects of the present invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

For a better understanding of the nature of the present invention, reference should be made in the detailed description taken in conjunction with the accompanying drawings in which:

FIG. 1 is a front view of a drinking straw 10, according to an exemplary embodiment of the present invention;

FIG. 2 is a side view of the drinking straw 10, according to an exemplary embodiment of the present invention; and

FIG. 3 is a bottom side view of the drinking straw 10, according to an exemplary embodiment of the present invention;

Like reference numerals refer to like parts throughout several views of the drawings.

### DETAILED DESCRIPTION OF THE INVENTION

The exemplary embodiments described herein detail for illustrative purposes are subject to many variations in structure and design. It should be emphasized, however that the present invention is not limited to a particular drinking structure shown and described. Rather, the principles of the present invention can be used with a variety of drinking straw structures. It is understood that various omissions, substitutions of equivalents are contemplated as circumstances may suggest or render expedient, but is intended to cover the application or implementation without departing from the spirit or scope of the claims of the present invention.

The present invention provides a drinking structure with a filtering end for consuming liquids, either hot or cold, while filtering against any unwanted objects (i.e., objects that are not desirable to be taken into mouth, for example, tea leaves, herbal infusions, seeds, and the like) present in the liquid to be consumed. The drinking structure prevents any burning of the user's lips while consuming a hot liquid. The present invention provides a drinking structure that does not suffer from clogging at the filtering end even after multiple uses.

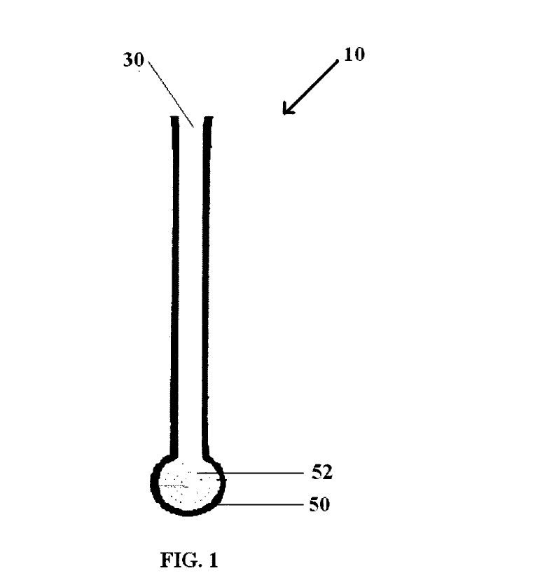

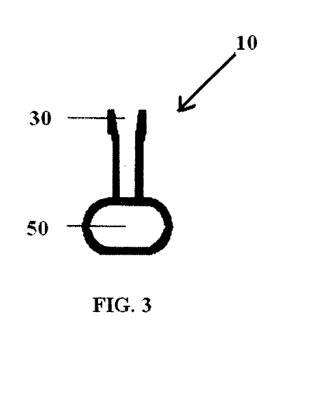

Referring now to FIGS. 1, 2, and 3 in one embodiment, a drinking straw 10 in the shape of a cylindrical elongated tube comprising a first end 30, and an opposite second end 50 leading to an expanded filtering section perpendicular to said cylindrical elongated tube thereby forming an inverse ‘T’ structure. The drinking straw 10 has a length, such that, the drinking straw 10 may be reached to a base of most common drinking containers.

The second end 50 has a plurality of perforations 52 on at least two walls (not shown) of the expanded filtering section The walls may be of any shape. The perforations 52 are so dimensioned; and have a size that filters a liquid to be consumed by a user, i.e., allowing passage of the liquid through the second end 50 and preventing passage of objects of a predetermined size in the liquid through the second end 50. The walls have a geometry that increases filter superficies of the second end 50, thereby preventing clogging at the second end 50.

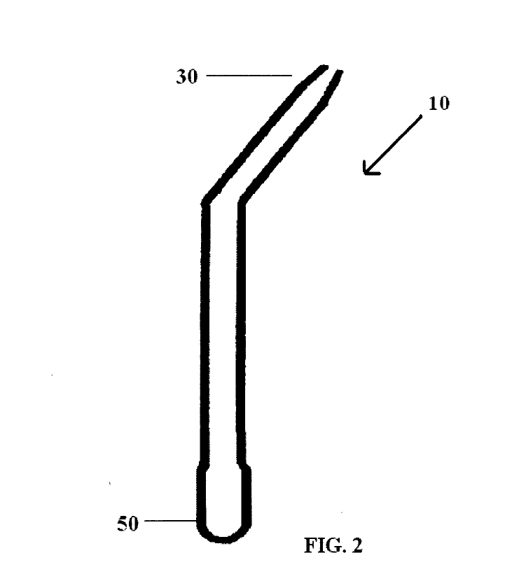

The first end 30 is receivable in the user's mouth for the purpose of oral suction of the liquid to be consumed. Preferably, the first end has flattened end geometry, and without being bound by theory, it is believed that, such geometry facilitates oral suction due to Bernoulli effect. Also, as illustrated in FIG. 2, the drinking straw 10 is curved at an angle at one-third of the length of the drinking straw 10 from the first end 30. Such a curve further facilitates oral suction by providing an optimized ergonomic shape.

The drinking straw 10 is made of a material that has a low thermal conductivity (e.g., glass), such that, there is minimal heat transmission to prevent any burning of user's lips while consuming the liquid. In one embodiment, the drinking straw 10 is made of glass. Preferably, the drinking straw 10 has a glass thickness of greater than or equal to about 1 millimeter to prevent cracking when consuming a hot liquid.

The drinking straw 10 of the present invention may be used to consume a liquid (either hot or cold), while filtering against objects of a predetermined size in the liquid. In one embodiment, a method for consuming a liquid from a drinking container comprises inserting the drinking straw 10 in the liquid, such that, the expanded filtering section of the second end 50 vertically touches a base of the drinking container, while the first end 30 is received in the user's mouth. Oral suction is applied by the user through the first end 30 to suck in the liquid through the second end 50. The perforations 52 allow passage of the liquid through the second end 50 and prevent passage of objects of a predetermined size in the liquid through the second end 50, thereby the user consuming a liquid free of unwanted particles of pre determined sizes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. An elongated tubular filtering structure with an open first end and an opposite expanded second end, said expanded second end having a plurality of perforations therein enabling said elongated tubular filtering structure to filter particles of a predetermined size in a fluid through said plurality of perforations, and allow said fluid to pass through said elongated tubular filtering structure for consumption.

2. An elongated tubular glass filtering structure comprising:
a cylindrical elongated tube with a first and an opposite second end, said first end capable of being received within a user's mouth for suction and said second end leading to an expanded filtering section perpendicular to said cylindrical elongated tube thereby forming an inverse ‘T’ structure, said filtering section having at least two walls with a plurality of perforations thereof to filter particles of a predetermined size in a fluid through said plurality of perforations and allow said fluid to pass through said elongated tubular glass filtering structure for consumption.

3. The elongated tubular glass filtering structure of claim 2, wherein said cylindrical elongated tube is curved at an angle at a distance from said first end to facilitate oral suction of said fluid.

4. The elongated tubular glass filtering structure of claim 2 wherein thickness of elongated tubular glass filtering structure may be greater than or equal to about 1 millimeter to prevent cracking when consuming a hot fluid.
